(19) United States
(12) Patent Application Publication
(10) Pub. No.: US 2014/0201051 A1
(43) Pub. Date: Jul. 17, 2014

(54) Master Feeder Structure For Pooled Investment Companies

(71) Applicant: FMR LLC, Boston, MA (US)

(72) Inventor: Marc Bryant, Hingham, MA (US)

(73) Assignee: FMR LLC, Boston, MA (US)

(21) Appl. No.: 13/741,559

(22) Filed: Jan. 15, 2013

(51) Int. Cl. G06Q 40/04

(52) U.S. Cl. CPC G06Q 40/04
USPC 705/37

(57) ABSTRACT

A computer-implemented method for operating a master trust that holds a portfolio of assets for plural feeder funds including at least a mutual fund and an exchange traded fund (ETF) is described. The master is a multi-class master fund of for feeder funds including an ETF class and mutual fund class. Shares in the ETF class and mutual fund class are exchanged between the mutual fund and master and the ETF and master according to types of transactions.

### BACKGROUND

This invention relates to fund operations.

There are several types of collective investment vehicles both registered and unregistered. For example, a mutual fund is an example of a registered vehicle, a company that brings together money from many people and invests it in a portfolio of stocks, bonds or other assets. Each investor in the fund owns shares of the fund, which represent a share of the investment portfolio. One type of mutual fund is a passively managed mutual fund, where the mutual fund manager seeks to replicate performance of a security index. These funds are commonly referred to as index funds. Alternatively, a mutual fund can be actively managed by a professional manager or a group of professional managers. In an actively managed fund, fund management uses its own judgment in deciding which securities to include in the mutual fund's portfolio.

A “commingled pool” is an example of an unregistered vehicle and is similar to a mutual fund because it combines the cash of many investors who own a share of the pool. Like mutual funds, commingled pools have a fund manager who manages the assets in the portfolio on behalf of all the shareholders. Commingled pools, however, are different from mutual funds in their structure and regulation. While a mutual fund is typically registered with the Securities and Exchange Commission (SEC) and is available to the general public, a commingled pool is not directly available to the public. Rather it is part of a group trust maintained by a bank for the collective investment of qualified pension or profit sharing plans or 401k plans. A group trust is maintained in accordance with applicable Internal Revenue Code and Department of Labor regulations.

An exchange-traded fund (“ETF”) is a type of investment fund that can share characteristics of both mutual funds and other exchange-traded assets like stocks. Like a mutual fund, an ETF issues shares representing a portion of its portfolio of securities. Like other exchange-traded assets (and unlike a mutual fund), an ETF is traded on a secondary market, such as on an exchange or over the counter at prices determined by supply and demand for the ETF taking into consideration current values of the assets in the ETF portfolio.

An ETF may be bought and sold in the primary market directly from the ETF by a market intermediary referred to as an Authorized Participant (or AP) or on a secondary market at market prices. APs in the primary market purchase large increments of shares (referred to as Creation Units), while secondary market shares are available to individual investors in smaller share increments via brokers.

### SUMMARY

According to an aspect, a computer-implemented method for operating a master trust that holds a portfolio of assets for plural feeder funds including at least a mutual fund and an exchange traded fund (ETF) including receiving, by one or more computers, a transfer of a pre-determined group of securities or cash along with purchase requests for ETF class master shares from an exchange traded fund, the securities for deposit into a master pool of assets that holds the portfolio for the feeder funds, calculating, by the one or more computers, a number of ETF class master shares in the master to exchange for the received pre-determined group of securities, causing transfer of the first number of ETF class master shares to the exchange traded fund for the received pre-determined group of financial assets, receiving, by the one or more computers, a transfer of a group of securities or cash along with purchase requests for mutual fund class master shares, from a mutual fund, the securities for deposit in the master pool of assets that holds the portfolio for the feeder funds, calculating, by the one or more computers, a number of mutual fund class master shares in the master to exchange for the received securities, and causing a transfer of the number of mutual fund class master shares to the mutual fund for the received securities from the mutual fund.

According to an additional aspect, a computer-implemented method for managing a master trust that holds a portfolio of assets for at least one of a registered investment company and unregistered investment company and holds a portfolio of assets for an exchange traded fund (ETF) includes receiving, by one or more computers, a transfer of a pre-determined group of securities along with purchase requests for ETF class master shares from an exchange traded fund, the securities for deposit into a master pool of assets that holds the portfolio for the at least one registered investment company and unregistered investment company, and the exchange traded fund, calculating, by the one or more computers, a number of ETF class master shares in the master to exchange for the received pre-determined group of securities, causing transfer of the first number of ETF class master shares to the exchange traded fund for the received pre-determined group of financial assets, receiving, by the one or more computers, a transfer of a group of securities along with purchase requests for the at least one registered investment company and unregistered investment company class master shares, the securities for deposit in the master pool of assets, calculating, by the one or more computers, a number of the at least one registered investment company and unregistered investment company class master shares to exchange for the received securities, and causing a transfer of the number of the at least one registered investment company and unregistered investment company class master shares to the at least one registered investment company and unregistered investment company for the received securities.

The registered investment company is a mutual fund. The unregistered investment company is a commingled fund. Determining net asset value of master shares comprises: NAV_{M}=(V+C−L)/S_{M} where: NAV_{M} is the net asset value of a master share; V is the total value of securities in the investment pool; C is cash on hand (and other assets); L liabilities (expenses, fees); and S_{M} total number of outstanding shares in the master.

According to an additional aspect, a computer program product tangible stored on a computer readable storage device for managing a master trust that holds a portfolio of assets for plural feeder funds including at least a mutual fund and an exchange traded fund (ETF) includes instructions to cause a processor to receive a transfer of a pre-determined group of securities or cash along with purchase requests for ETF class master shares from an exchange traded fund, the securities for deposit into a master pool of assets that holds the portfolio for the mutual fund and the exchange traded fund, calculate a number of ETF class master shares in the master to exchange for the received pre-determined group of securities, cause transfer of the first number of ETF class master shares to the exchange traded fund for the received pre-determined group of financial assets, receive a transfer of a group of securities or cash along with purchase requests for mutual fund class master shares, from a mutual fund, the securities for deposit in the master pool of assets that holds the portfolio of the mutual fund and the exchange traded fund, calculate a number of mutual fund class master shares in the master to exchange for the received securities, and cause a transfer of the number of mutual fund class master shares to the mutual fund for the received securities from the mutual fund.

According to an additional aspect, an apparatus includes a processor device, memory, and a computer program product tangible stored on a computer readable storage device for managing a master trust that holds a portfolio of assets for plural feeder funds including at least a mutual fund and an exchange traded fund (ETF), the product including instructions to cause the processor to receive a transfer of a pre-determined group of securities or cash along with purchase requests for ETF class master shares from an exchange traded fund, the securities for deposit into a master pool of assets that holds the portfolio for the mutual fund and the exchange traded fund, calculate a number of ETF class master shares in the master to exchange for the received pre-determined group of securities;, cause transfer of the first number of ETF class master shares to the exchange traded fund for the received pre-determined group of financial assets, receive a transfer of a group of securities or cash along with purchase requests for mutual fund class master shares, from a mutual fund, the securities for deposit in the master pool of assets that holds the portfolio of the mutual fund and the exchange traded fund, calculate a number of mutual fund class master shares in the master to exchange for the received securities, and cause a transfer of the number of mutual fund class master shares to the mutual fund for the received securities from the mutual fund.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of a master-feeder structure.

FIG. 2 is a flow diagram depicting aspects of master-feeder management.

FIG. 3 is a flow diagram depicting transfers between a master system and feeders.

FIG. 4 is a flow diagram of master fund NAV calculation.

FIG. 5 is a flow diagram depicting buying/creation transactions between feeders and the master system.

FIG. 6 is a flow diagram depicting a NAV calculation by a mutual fund system.

FIG. 7 is a flow diagram depicting selling/redemption transactions with the master.

### DETAILED DESCRIPTION

Investment company sponsors may offer different types of funds that each issue shares representing the same portfolio of assets. For example, an investment company sponsor may offer a traditional open-end mutual fund, a commingled pool, and an ETF that track the same Index or follow the same, active investment strategy by investing in the same securities.

Described below are mechanisms that permit a traditional open-end mutual fund, unregistered fund, e.g., a commingled pool, and ETF, each of which tracks the same Index or that otherwise employs the same investment strategy and thus represents the same portfolio of assets, to pool assets into an investment company that is organized to hold and manage a common investment pool. This investment company, referred to herein as the master or master trust, receives assets from the traditional open-end mutual fund, commingled pool, and ETF and deposits those assets into a single pool of assets that are managed in the “master” trust. This approach may provide economies of scale or efficiencies for the open-end mutual fund, commingled pool, and ETF collectively referred to hereinafter as “feeders.”

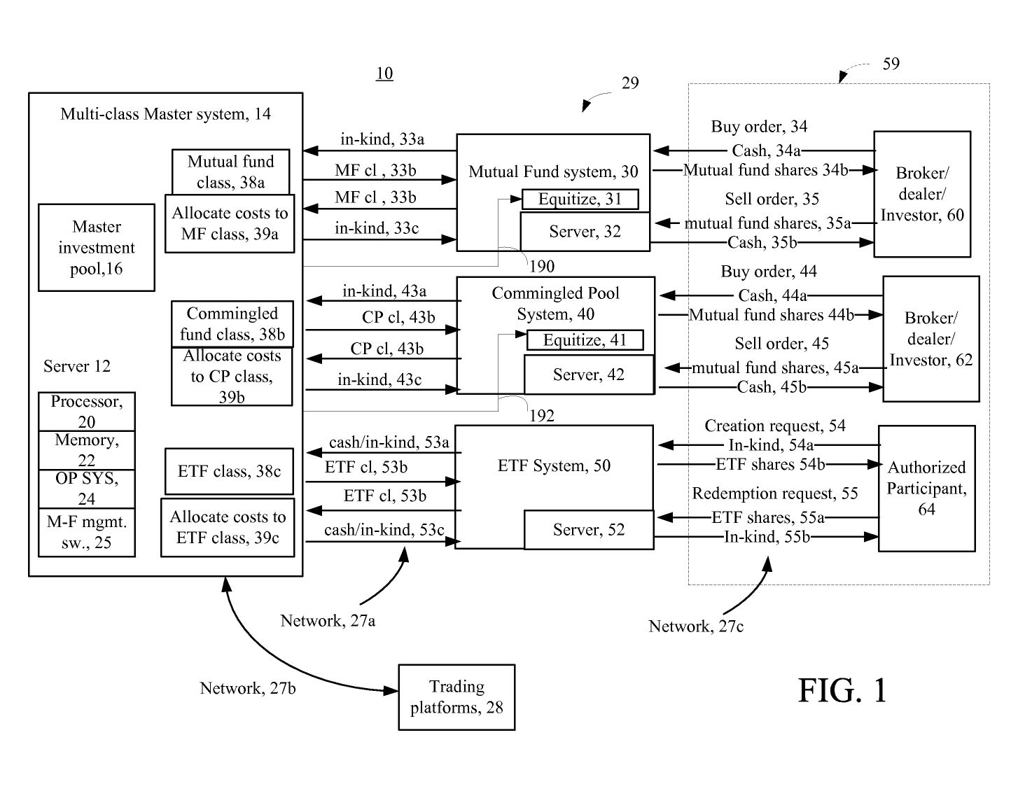

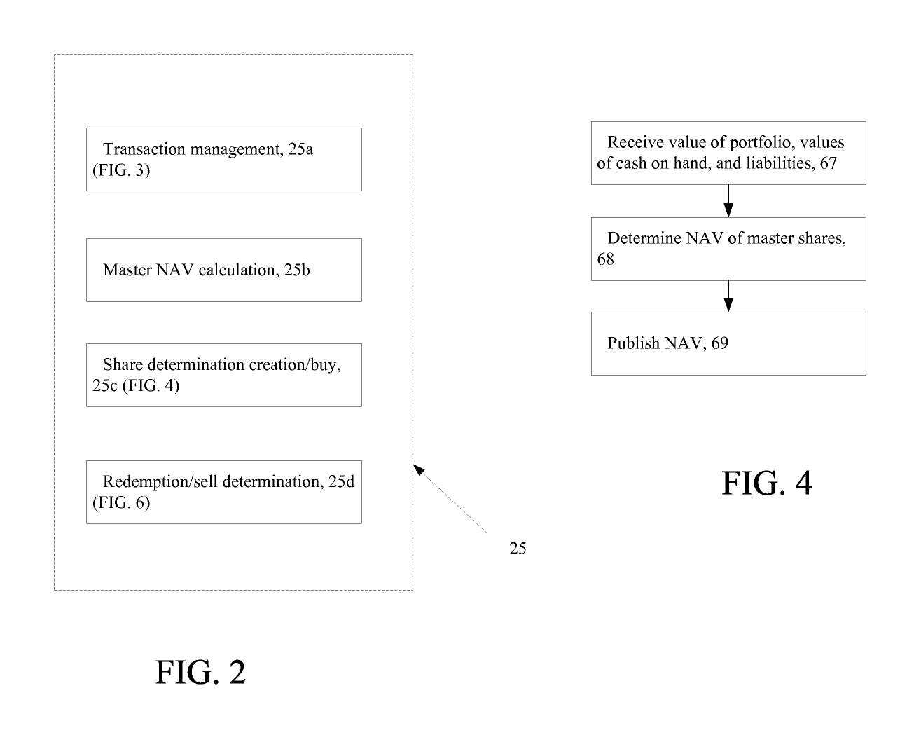

Referring now to FIG. 1, a multi-class master-feeder structure 10 includes a multi-class master system 14, feeder systems 29 and investor systems 59. The multi-class master system 14 includes a server 12 that is one or more computer systems, including processor 20, memory 22 and an operating system software 24 and master-feeder management software 25, as will be described in FIG. 2. The master system 14 also includes a master investment pool 16 and multiple, here three share classes, including a mutual fund share class 38a, a commingled pool share class 38b, and an ETF share class 38c.

The multi class master 14 issues different classes of shares, e.g., “(MF cl)”, “(CP cl)” and “(ETF cl)” to each of the different, respective feeders 29. The multi-class master 14 enables allocation of expenses/costs 39a-39c to the respective feeders 29 through the share classes.

The master investment pool 16 holds assets for plural feeder investment companies, such as the mutual fund system 30, commingled pool system 40, and exchange traded fund (ETF) system 50, as shown. The master investment pool 16 through server 12 conducts securities transactions with trading platforms 28, via a network 27b. Such transactions involve other, conventional third party systems (not depicted) such as market makers, dealers, clearing houses, markets, exchanges, over the counter markets, etc.

Each of the mutual fund system 30, commingled pool system 40, and exchange traded fund (ETF) system 50 includes respective server computers such as the mutual fund system server 32, commingled pool system server 42, and exchange traded fund (ETF) system server 52 to manage transactions 33a-33d; 43a-43d; and 53a-53d, respectively, with the master system 14 over a network 27a. In some embodiments, these server computers can be the same server computer. That is, each feeder is operated on the same server or sets of servers, whereas in other embodiments the sets of server computers are different for each feeder. Each of the mutual fund system server 32, commingled pool system server 42, and exchange traded fund (ETF) system server 52 also manage transactions 34a-34d; 44a-43d; and 54a-54d, and 35a-35d; 45a-45d; and 55a-55d, respectively with participant systems 59, e.g., broker/dealer or Investor systems 60, broker/dealer or investor systems 62 and authorized participant systems 64 over a network 27c. Separate systems to manage transactions with the master and transactions with the participant systems 59 could be used.

In this structure, the mutual fund system 30 and commingled pool 40 include equitize functionality 31, e.g., as shown for the mutual fund system 30 and equitize functionality 41 as shown for the commingled pool. The equitize functionality 31, 41 causes the mutual fund, commingled pool to equitize cash received from investors (transactions 34a, 44a) into in-kind securities, accordingly to a portfolio required by the master, which is either sent via a message 190, 192 (or inferred or otherwise), that are transferred to the master (transactions 33a, 43a) (often with a small amount of “balancing cash”) when buying master shares, and requires the feeders to receive securities from the master (transactions 33c, 43c) (often with a small amount of “balancing cash”) and de-equitize the shares into cash to deliver (transactions 34c, 44a) to investors when selling master shares back to the master. By requiring that the feeders equitize cash into securities, this arrangement, isolates transaction costs and potential tax implications to the respective feeder structures 30, 40 rather than the master trust 14. In some embodiments, ETF feeders can invest in the master entirely in cash.

As depicted in FIG. 1, broker dealer systems/investor systems 60, 62 are meant to indicate that the transactions can be performed by either or both of broker dealer systems and investor systems. Further, in some embodiments, systems 60, 62 and possibly system 64 need not be computer systems but could be other types of systems. For example, some mutual funds investors could buy/sell shares directly with the mutual fund, via telephone or mail and thus need not deal with a broker dealer or use a computer to make such transactions. With respect to the mutual fund system 30, broker dealer and/or individual investors transact directly with mutual fund system 30 to purchase or sell mutual fund shares. The mutual fund transacts with a broker dealer and/or individual investors at the next calculated net asset value (NAV) of the mutual fund, as will be described below.

An entity that desires to purchase shares or sell existing shares of a mutual fund purchases or sells the shares either directly with the mutual fund or through a broker-dealer that purchases or sells shares directly with the mutual fund. Typically, the mutual fund pays cash to a shareholder when selling shares in an amount equal to the next-published NAV per share sold, but may give the shareholder a slice of the fund's portfolio of securities equal to the value of shares sold (where, again, the shares and portfolio securities are valued according to the fund's next-published NAV). The latter scenario is referred to as “redemption in kind.” With respect to the commingled system 40, investors transact directly with commingled system 40, typically only to the extent that the investors are part of a legal trust, e.g., a 401K plan or the equivalent.

With respect to the ETF system 50, only “authorized participants” 64 may transact directly with ETF system 50 to purchase or redeem ETF shares. An authorized participant is an entity chosen by an investment company that operates and sponsors the ETF system 50 to undertake the responsibility of obtaining the assets needed to create ETF shares. Authorized participants also may make markets in the ETF shares for their own account, or may act as agent or principal with respect to transactions on behalf of their customers. Authorized participants are typically broker dealers. Once an authorized participant receives ETF shares, the authorized participant may trade those shares on a secondary market.

Typically, the ETF system 50 creates or redeems ETF shares in collections of a predefined size. A collection of this predefined size is called a creation unit. Creation units are typically 50,000 shares, but in principle may be any size. Authorized participants transact with the ETF system 50 in creation unit aggregations (typically in kind) 54 (e.g., with a pre-determined group of financial assets) or cash (for fixed-income type of instruments) as a medium of exchange. The ETF system 50 transacts with the master trust 14 (or in some embodiments a master organized as a partnership) by transferring the received media of exchange to the master trust and receiving in exchange a predetermined number of shares in the master trust.

The medium of exchange with an ETF may include both securities and cash, in a so-called “hybrid” transaction, all securities or all cash. Such a hybrid transaction is appropriate when, for example, it would be impractical for the authorized participant to obtain a part of the requisite pre-determined group of financial assets because some such financial assets are in short supply. In this case, the authorized participant may replace the unavailable financial assets with an agreed upon amount of cash.

Note in some implementations trading platforms 28 (shown) need not be accessed by the master system 14, whereas such trading platforms would be accessed (not shown) by the equitize functionality 31, 41. When the feeders equitize cash into securities, this arrangement, isolates transaction costs and potential tax implications to the feeder structures 30, 40 that incur them rather than requiring the master trust 14 to bear these costs.

Referring now to FIG. 2, the master-feeder management software 25 includes transaction management functionality 25a to interact with the feeder structures 29 that feed into the master investment pool 16. The master-feeder management software 25 includes NAV calculations 25b to determine an NAV of master shares. The master-feeder management software 25 also includes share determination processing 25c to determine a number of master shares to issue to the feeders 29. The master-feeder management software 25 also includes redemption processing 25d to determine an amount of assets to return to feeders 29 in response to redemption requests and identify specific security types and lots to deliver based on various factors. The master-feeder management software 25 may include other functionalities, such as share class accounting.

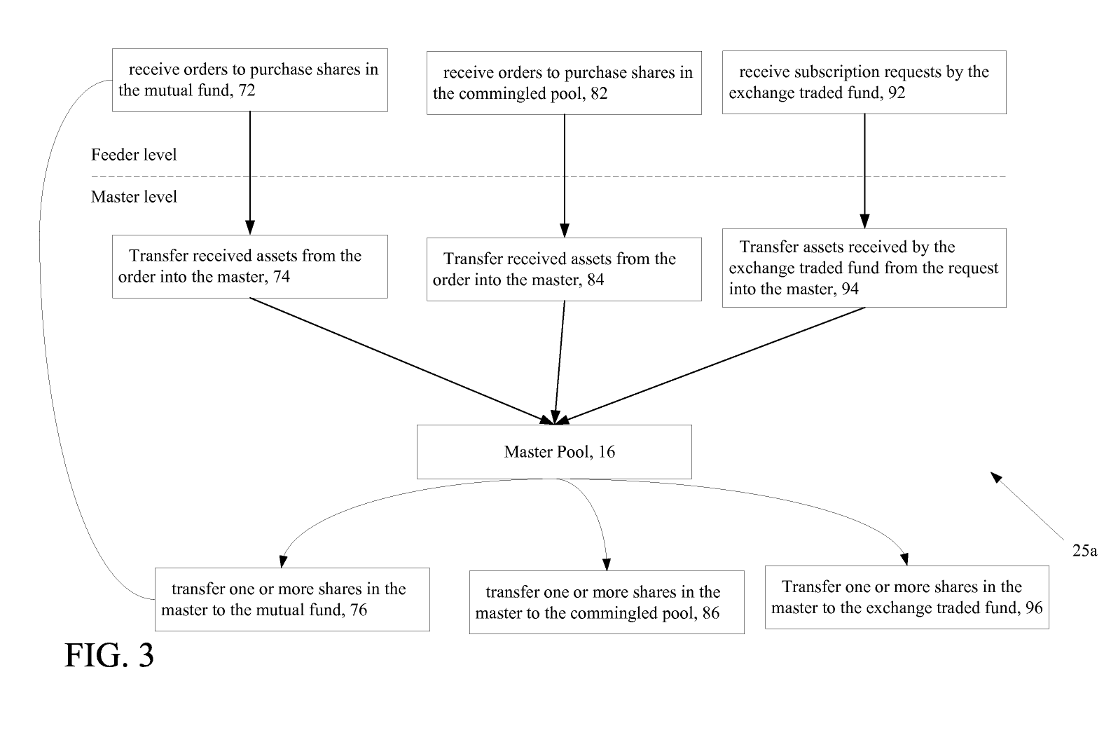

Referring now to FIG. 3, (and also FIG. 1 for transactions) for the mutual fund that receives 72 orders (transaction 34, FIG. 1) to purchase shares in the mutual fund, the master-feeder management software 25 transaction management 25a causes the server 28 to transfer 74 the received assets that accompany (according to settlement rules) the order to the multi-class master 14 (transaction 33a, FIG. 1) upon settlement and transfer 76 shares in the master to the mutual fund (transaction 33b, FIG. 1).

For the commingled pool that receives 82 orders (transaction 44, FIG. 1) to purchase shares in the commingled pool, transaction management 25a causes the server 28 to transfer 84 received assets that accompany the order into the master (transaction 44a, FIG. 1) and transfer 86 shares in the master to the commingled pool (transaction 44b, FIG. 1).

For the ETF that receives 92 creation (or subscription) requests (transaction 54, FIG. 1), transaction management 25a causes the server 28 to transfer 94 assets received from the exchange traded fund from the request into the master (transaction 54a, FIG. 1) and transfer 96 shares in the master to the exchange traded fund (transaction 54b, FIG. 1).

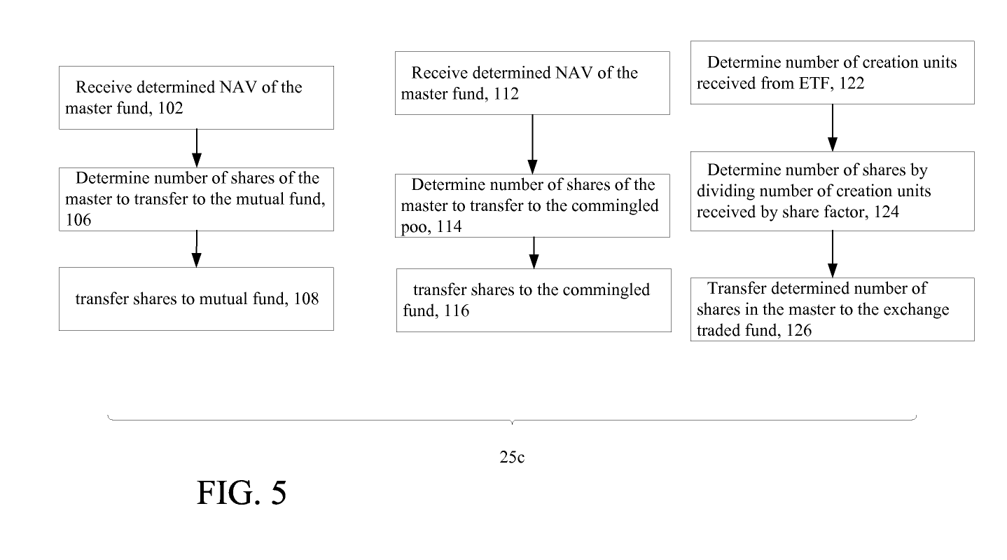

Referring to FIG. 4, the master-feeder management software 25 calculates the NAV of the master fund shares 25b, by receiving 67 values of the securities, cash and liabilities and determining the NAV, 68 according to a formula such as that shown below, and thereafter publishes 69 an NAV valuation of master trust shares. This calculation is performed each business day at the close of trading.

In one embodiment, the master-feeder management software 25 determines the NAV of the master fund at the end of a trading day generally related to:

NAV_{M}=(V+C−L)/S_{M}

where:
NAV_{M} is the net asset value of a master share
V is the total value of securities in the investment pool 16
C is cash on hand (and other assets)
L liabilities (expenses, fees of the master fund)
S_{M} total number of outstanding shares in master

In another embodiment, certain assets and fees/expenses can be allocated among the share classes. In such an embodiment the NAV is calculated generally related to:

Mutual Fund Class

NAV_{Mmf class}=(V−Lₘ−L_{mf}+C_{mf})/S_{M}

where:
NAV_{Mmf class} is the net asset value of a master share for the mutual fund class
V is the total value of securities in the investment pool 16
C_{mf} is cash on hand (and other assets) attributed to the mf class
Lₘ are liabilities attributed to all classes (general expense of the master)
L_{mf} are liabilities attributed to the MF class (expenses chargeable to the mutual fund, 39a)
S_{M} total number of outstanding shares in master

Commingled Fund Class:

NAV_{Mcd class}=(V−Lₘ−L_{cd}+C_{cd})/S_{M}

where:
NAV_{Mcd class} is the net asset value of a master share for the mutual fund class
V is the total value of securities in the investment pool 16
C_{cd} is cash on hand (and other assets) attributed to the cd class
Lₘ are liabilities attributed to all classes (general expense of the master)
L_{cd} are liabilities attributed to the cd class (expenses chargeable to the commingled fund, 39b)
S_{M} total number of outstanding shares in master

ETF Class:

NAV_{Metf class}=(V−Lₘ−L_{etf}+C_{etf})/S_{M}

where:
NAV_{Metf class} is the net asset value of a master share for the ETF class
V is the total value of securities in the investment pool 16
C_{etf} is cash on hand (and other assets) attributed to the eft class
Lₘ are liabilities attributed to all classes (general expense of the master)
L_{etf} are liabilities attributed to the etf class (expenses chargeable to the ETF, 39c, such as transaction fees incurred by creation/redemption)
S_{M} total number of outstanding shares in master

Thus, when the mutual fund system 30, the commingled pool system 40 and the ETF system 50 each calculate their respective NAV's, the respective feeders 29 will use the NAV for the respective class, which reflects differences in expenses and fees charged by the master to that class to account for the allocation of expense/fees to the different share classes.

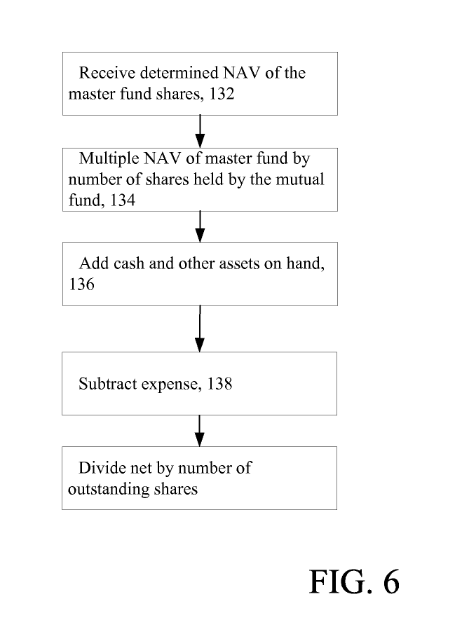

Referring now to FIG. 5, the share determination processing 25c determines the number of shares to transfer to each of the feeders 29 in response to receipt of assets from the respective feeders 29.

The share determination processing 25c determines 122 for creation requests (also referred to herein as subscription requests) received by the ETF system 50, a number of creation units worth of assets received from the ETF system 50 as a result of the received creation request. The share determination processing 25c determines 124 the number of shares to transfer by dividing number of creation units received by a share factor. The master-feeder management software 25 causes a transfer 126 of the determined number of shares in the master to the ETF system 50. The master-feeder management software 25 can use a share factor of one to one. That is, for a creation unit size of in-kind assets transferred into the master, the master will issue one master share to the ETF system 50. Alternatively, the master-feeder management software 25 can use a share factor of one ETF share corresponds to one master share. That is, for a creation unit size of in-kind assets transferred into the master, that equates to, e.g., 50,000 ETF shares, the master will issue 50,000 master shares to the ETF system 50. These are but several examples, and any share factor ratio of master shares to equate to a creation unit could be used. In addition there can be a 1 to 1 ratio among the classes or other ratios.

The master issues either whole or whole and fractional numbers of master shares to the mutual fund system 30 in response to a receipt of securities (FIG. 1) from the mutual fund system 30. Any of a number of ways can be used to determine the number of master shares to issue. For example, the master receives/retrieves 102 the NAV of the master fund shares and determines 104 the number of shares to transfer to the mutual fund by dividing the total value of the securities received from the mutual fund system 30 by the NAV of a master share, and transfers 106 the resulting number of master shares in the master that equate to the total value of cash and/or securities received from the mutual fund system 30.

The master-feeder management software 25 determines shares for the commingled pool system 40 in a similar manner as for the mutual fund system 30. The master issues either whole or whole and fractional numbers of master shares to the commingled pool system 40 in response to a receipt of securities (FIG. 1) from the commingled pool system 40. Any of a number of ways can be used to determine the number of master shares to issue. For example, the master receives/retrieves 112 the NAV of the master fund shares and determines 114 the number of shares to transfer to commingled pool by dividing the total value of the cash and/or securities received from the commingled pool system 40 by the NAV of a master share and transfers 116 the resulting number of master shares in the master that equate to the total value of cash and/or securities received from the commingled pool system 40.

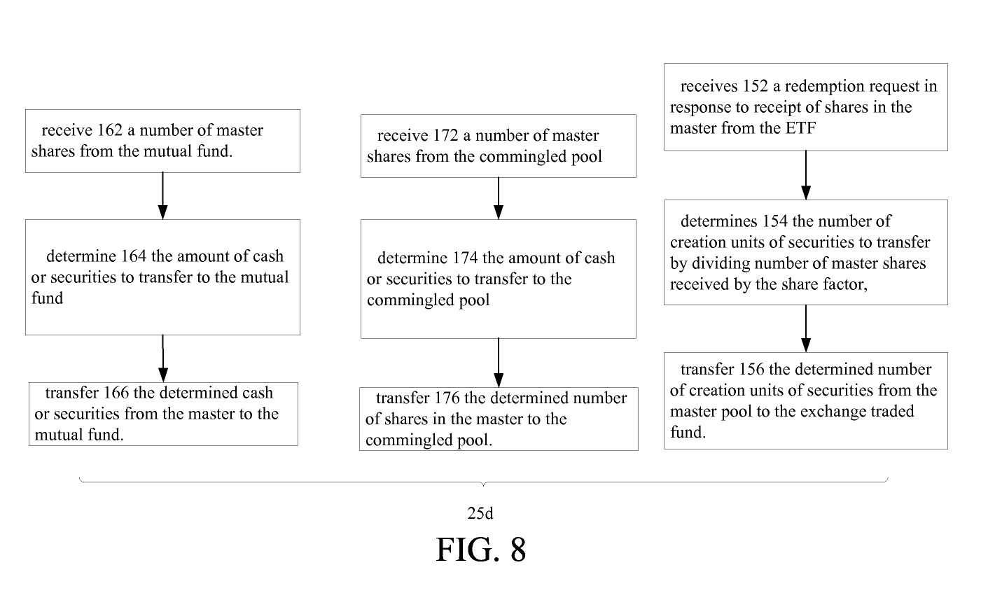

Referring now to FIG. 6, NAV's of shares in the mutual fund, commingled pool and ETF are determined by the respective mutual fund, commingled pool and ETF server systems 32, 42 and 52. For example, the mutual fund at the close of trading receives 132 the determined NAV of the master fund shares and multiplies the received NAV of master fund shares by the number of master shares held by the mutual fund to provide a first value. To this first value, the amount of cash and other assets held by the mutual fund on hand is added and liabilities (expenses and fees) of the mutual fund are subtracted, providing a second value. From this second value, the NAV per share is determined by dividing this second value by number of outstanding shares in the mutual fund.

NAV_{mf}=((NAV_{M}*N)+C−L))/S_{mf}

where:
NAV_{mf} is the net asset value of a mutual fund share
NAV_{M} is the net asset value of a master share
N is the number of master shares
C is cash on hand (and other assets)
L liabilities (expenses, fees chargeable to mutual fund shareholders)
S_{mf} total number of shares in the mutual fund

Similar calculations can be provided for the ETF and the commingled pool to provide corresponding NAV's using the respective values of cash on hand and expenses.

Unlike an ETF, the mutual fund system 30 and commingled pool system 40 may have significant amounts of cash on hand either because the mutual fund system 30 and commingled pool system 40 need to maintain a certain amount of cash to cover sales of shares back to the mutual fund system 30 and commingled pool system 40 or because the cash from shareholder purchase of mutual fund or commingled pool shares cannot be readily invested in the desired securities. This so called “cash drag” serves to potentially lower the return of a mutual fund and a commingled pool, and which is typically not a concern in an ETF. Thus, by having the mutual fund and the commingled pool hold cash that cannot yet be invested in the mutual fund system 30 and commingled pool system 40 those systems and not the ETF system 50 would bear the effects of the cash drag. In some implementations the ETF system 50 may also have hold significant amounts of cash and thus in this implementation the ETF system 50 would bear the effects of cash drag.

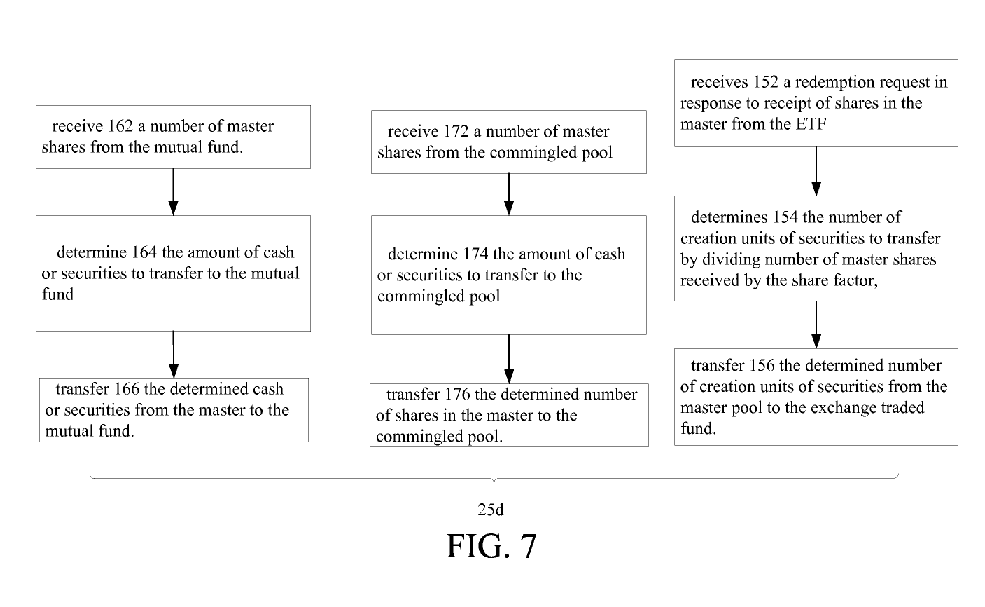

Referring now to FIG. 7, the master-feeder management software 25 also includes redemption processing 25d to determine the amount of assets to transfer to each of the feeders 29 in response to receipt of redemption requests or sell orders. The master-feeder management software 25 will also determine/identify specific lots for transfer to the various feeders depending on which feeder is redeeming.

The master-feeder management software 25 receives 152 a redemption request in response to receipt of shares in the master from the ETF, and thus determines the number of creation units of securities to send to the ETF feeder. Typically ETF's only deal in whole number creation unit sizes. The master-feeder management software 25 determines 154 the number of creation units of securities to transfer by dividing (implicitly or explicitly) number of master shares received by the share factor (used during creation of ETF shares), and thereafter transfers 156 the determined number of creation units of securities from the master investment pool 16 to the exchange traded fund. The master-feeder management software 25 uses the same share factor as was used for creation requests (e.g., one (1) master share equals one (1) creation unit or one (1) master share equals one (1) ETF share) or other ratios, as discussed above.

The functionality 25d of the master-feeder management software 25 also includes functionality to determine the amount of cash or shares to transfer to the other two feeders 29, e.g., the mutual fund and the commingled pool in response to receipt of sell orders from those feeders 29.

For the mutual fund, the sell processing 25d uses the determined NAV value of a master share at closing prices of securities. The master receives 162 a number of master shares from the mutual fund. Given the number of master shares the master will issue securities to the mutual fund in an amount equal to the value of master shares sold back to the master. For the in-kind transfers of securities, the master transfers 166 that value of in-kind securities to the mutual fund, such as by a/transfer of a slice of the pool that equates to the value of the master shares tendered back to the master fund from the mutual fund at the NAV of the master shares. In the platform of FIG. 1, when the master transfers securities the master does not typically incur transaction costs. Similar considerations apply for the commingled pool.

For the commingled pool, the sell processing 25d uses the determined NAV value of a master share at the closing prices. The master receives 172 a number of master shares from the commingled pool. Given the number of master shares, the master will issue securities to the commingled pool in an amount equal to the value of master shares sold back to the master. For the in-kind transfers of securities, the master transfers 176 that value of in-kind securities to the commingled pool, for example, transferring of a slice of the pool that equates to the value of the master shares tendered back to the master fund from the commingled pool at the NAV of the master shares

For redemption processing the NAV used will be either the embodiment of the single NAV that applies to all share classes or the embodiment of the NAV that calculates separate NAV's for each feeder, according to the particular embodiment of the system 10.

Participant devices can be any sort of device such as a telephone to receive orders and/or a computing device capable of taking input from a user and communicating over a network with a server and/or with other client devices, as appropriate. For example, a mobile device, a desktop computer, a laptop, a cell phone, a private digital assistant (“PDA”), a server, an embedded computing system, a mobile device, and so forth could be used as a participant device.

Server can be any of a variety of computing devices capable of receiving information, such as a server, a distributed computing system, a desktop computer, a laptop, a cell phone, a rack-mounted server, and so forth. Server may be a single server or a group of servers that are at a same location or at different locations.

Server can receive information from client devices via interfaces. Interfaces can be any type of interface capable of receiving information over a network, such as an Ethernet interface, a wireless networking interface, a fiber-optic networking interface, a modem, and so forth. Server also includes a processor and memory. A bus system (not shown), including, for example, an information bus and a motherboard, can be used to establish and to control information communication between the components of server.

Processor may include one or more microprocessors. Generally, processor may include any appropriate processor and/or logic that is capable of receiving and storing information, and of communicating over a network (not shown). Memory can include a hard drive and a random access memory storage device, such as a dynamic random access memory, machine-readable media, or other types of non-transitory machine-readable storage devices.

Components also include storage device, which is configured to store information such as the instruction code to implement the processes disclosed herein.

Embodiments can be implemented in digital electronic circuitry, or in computer hardware, firmware, software, or in combinations thereof. Apparatus of the invention can be implemented in a computer program product tangibly embodied or stored in a computer readable storage device and/or machine readable storage device for execution by a programmable processor; and method actions can be performed by a programmable processor executing a program of instructions to perform functions and operations of the invention by operating on input information and generating output. The invention can be implemented advantageously in one or more computer programs that are executable on a programmable system including at least one programmable processor coupled to receive information and instructions from, and to transmit information and instructions to, an information storage system, at least one input device, and at least one output device. Each computer program can be implemented in a high-level procedural or object oriented programming language, or in assembly or machine language if desired; and in any case, the language can be a compiled or interpreted language.

Suitable processors include, by way of example, both general and special purpose microprocessors. Generally, a processor will receive instructions and information from a read-only memory and/or a random access memory. Generally, a computer will include one or more mass storage devices for storing information files; such devices include magnetic disks, such as internal hard disks and removable disks; magneto-optical disks; and optical disks. Storage devices suitable for tangibly embodying computer program instructions and information include all forms of non-volatile memory, including by way of example semiconductor memory devices, such as EPROM, EEPROM, and flash memory devices; magnetic disks such as internal hard disks and removable disks; magneto-optical disks; and CD ROM disks. Any of the foregoing can be supplemented by, or incorporated in, ASICs (application-specific integrated circuits).

A number of embodiments of the invention have been described. Nevertheless, it will be understood that various modifications may be made without departing from the spirit and scope of the invention. Accordingly, other embodiments are within the scope of the following claims.

1. A computer-implemented method for operating a master trust that holds a portfolio of assets for plural feeder funds including at least a mutual fund and an exchange traded fund (ETF), the method comprising:
receiving, by one or more computers, a transfer of a pre-determined group of securities and/or cash along with purchase requests for ETF class master shares from an exchange traded fund, the securities for deposit into a master pool of assets that holds the portfolio for the plural feeder funds;
calculating, by the one or more computers, a number of ETF class master shares in the master to exchange for the received pre-determined group of securities;
causing transfer of the first number of ETF class master shares to the exchange traded fund for the received pre-determined group of financial assets and/or cash;
receiving, by the one or more computers, a transfer of a group of securities and/or cash along with purchase requests for mutual fund class master shares, from a mutual fund, the securities for deposit in the master pool of assets that holds the portfolio of the feeder funds;
calculating, by the one or more computers, a number of mutual fund class master shares in the master to exchange for the received securities and/or cash; and
causing a transfer of the number of mutual fund class master shares to the mutual fund for the received securities and/or cash from the mutual fund.

2. The method of claim 1, wherein the master pool further holds assets for a commingled pool, the method further comprising:
receiving, by the one or more computers, a transfer of a pre-determined group of securities and/or cash along with purchase requests for commingled pool class master shares from a commingled pool, the securities for deposit in the master pool of assets that holds the portfolio for the mutual fund, the exchange traded fund and the commingled pool;
calculating, by the one or more computers, a number of commingled pool class master shares to exchange for the received pre-determined group of securities; and
causing a transfer of the number of commingled pool class master shares to the commingled pool for the received pre-determined group of securities.

3. The method of claim 1, wherein the one or more computer systems each comprise:
at least a processor and a memory coupled to the processor, configured to:
manage transactions between the master and each of the mutual fund and exchange traded fund;
determine a net asset valuation of master shares; and
perform share creation and redemption processing.

4. The method of claim 2, wherein determining net asset value of master shares comprises:
NAV_{M}=(V+C−L)/S_{M}
where:
NAV_{M} is the net asset value of a master share
V is the total value of securities in the investment pool
C is cash on hand (and other assets)
L liabilities (expenses, fees)
S_{M} total number of outstanding shares in the master.

5. The method of claim 2, wherein performing share creation processing further comprises:
determining for creation requests received from ETF a number of creation units worth of securities received; and
dividing number of creation units received by a share factor.

6. The method of claim 5, the share factor is a ratio of a number of master shares to a creation unit.

7. The method of claim 2, calculating the number of mutual fund class master shares further comprises:
determining the number of mutual fund class master shares to transfer to the mutual fund by dividing the value of the pre-determined group of securities received from the mutual fund by a net asset value of a mutual fund class master share.

8. The method of claim 1, calculating the number of commingled class master shares further comprises:
determining the number of commingled class master shares to transfer to the commingled pool by dividing the value of the predetermined group of securities received from the commingled pool by a net asset value of a commingled class master share.

9. The method of claim 2, wherein determining net asset value of master shares are determined according to master share class.

10. The method of claim 2, wherein determining net asset value of master shares are determined according to master share class according to:
NAV_{M}=(V+C−L)/S_{M}
where:
NAV_{M} is the net asset value of a master share
V is the total value of securities in the investment pool
C is cash on hand (and other assets)
L liabilities (expenses, fees)
S_{M} total number of outstanding shares in the master, and
wherein the value of L is L_{etf} that reflects expenses/costs attributed to the ETF feeder for calculating the NAV of the ETF class plus L_{mf} that reflects expenses/costs attributed to the mutual fund feeder for calculating the NAV of the mutual fund class, and L_{cp} that reflects expenses/costs attributed to the commingled feeder for calculating the NAV of the commingled feeder class.

11. A computer-implemented method for managing a master trust that holds a portfolio of assets for at least one of a registered investment company and unregistered investment company, and holds a portfolio of assets for an exchange traded fund (ETF), the method comprising:
receiving, by one or more computers, a transfer of a pre-determined group of securities along with purchase requests for ETF class master shares from an exchange traded fund, the securities for deposit into a master pool of assets that holds the portfolio for the at least one registered investment company and unregistered investment company, and the exchange traded fund;
calculating, by the one or more computers, a number of ETF class master shares in the master to exchange for the received pre-determined group of securities;
causing transfer of the first number of ETF class master shares to the exchange traded fund for the received pre-determined group of financial assets;
receiving, by the one or more computers, a transfer of a group of securities along with purchase requests for the at least one registered investment company and unregistered investment company class master shares, the securities for deposit in the master pool of assets;
calculating, by the one or more computers, a number of the at least one registered investment company and unregistered investment company class master shares to exchange for the received securities; and
causing a transfer of the number of the at least one registered investment company and unregistered investment company class master shares to the at least one registered investment company and unregistered investment company for the received securities.

12. The method of claim 11, wherein the at least one of registered investment company and unregistered investment company, is a registered investment company that is a mutual fund.

13. The method of claim 11, wherein the at least one of registered investment company and unregistered investment company, is an unregistered investment company that is a commingled fund.

14. The method of claim 11, wherein determining net asset value of master shares comprises:
NAVM=(V+C−L)/SM
where:
NAVM is the net asset value of a master share
V is the total value of securities in the investment pool
C is cash on hand (and other assets)
L liabilities (expenses, fees)
SM total number of outstanding shares in the master.

15. The method of claim 12, further comprising performing share creation by determining for creation requests received from ETF a number of creation units worth of securities received; and
dividing number of creation units received by a share factor.

16. The method of claim 15, the share factor is a ratio of a number of master shares to a creation unit.

17. A computer program product tangible stored on a computer readable storage device for managing a master trust that holds a portfolio of assets for plural feeder funds including at least a mutual fund and an exchange traded fund (ETF), the product comprising instructions to cause a processor to:
receive a transfer of a pre-determined group of securities or cash along with purchase requests for ETF class master shares from an exchange traded fund, the securities for deposit into a master pool of assets that holds the portfolio for the mutual fund and the exchange traded fund;
calculate a number of ETF class master shares in the master to exchange for the received pre-determined group of securities;
cause transfer of the first number of ETF class master shares to the exchange traded fund for the received pre-determined group of financial assets;
receive a transfer of a group of securities or cash along with purchase requests for mutual fund class master shares, from a mutual fund, the securities for deposit in the master pool of assets that holds the portfolio of the mutual fund and the exchange traded fund;
calculate a number of mutual fund class master shares in the master to exchange for the received securities; and
cause a transfer of the number of mutual fund class master shares to the mutual fund for the received securities from the mutual fund.

18. An apparatus, comprising:
a processor device;
memory; and
a computer program product tangible stored on a computer readable storage device for managing a master trust that holds a portfolio of assets for plural feeder funds including at least a mutual fund and an exchange traded fund (ETF), the product comprising instructions to cause the processor to:
receive a transfer of a pre-determined group of securities or cash along with purchase requests for ETF class master shares from an exchange traded fund, the securities for deposit into a master pool of assets that holds the portfolio for the mutual fund and the exchange traded fund;
calculate a number of ETF class master shares in the master to exchange for the received pre-determined group of securities;
cause transfer of the first number of ETF class master shares to the exchange traded fund for the received pre-determined group of financial assets;
receive a transfer of a group of securities or cash along with purchase requests for mutual fund class master shares, from a mutual fund, the securities for deposit in the master pool of assets that holds the portfolio of the mutual fund and the exchange traded fund;
calculate a number of mutual fund class master shares in the master to exchange for the received securities; and
cause a transfer of the number of mutual fund class master shares to the mutual fund for the received securities from the mutual fund.
